(19) United States
(12) Patent Application Publication
(10) Pub. No.: US 2014/0053924 A1
(43) Pub. Date: Feb. 27, 2014

(54) VALVE CONTROL FOR FLUID SYSTEM

(71) Applicant: Andrew F. Lawson, Milwaukee, WI (US)

(72) Inventor: Andrew F. Lawson, Milwaukee, WI (US)

(73) Assignee: Caterpillar Global Mining LLC, South Milwaukee, WI (US)

(21) Appl. No.: 13/594,967

(22) Filed: Aug. 27, 2012

(51) Int. Cl. F16K 31/44; F16K 1/22; F16K 37/00

(52) U.S. Cl. 137/554; 251/231; 251/305; 222/556

(57) ABSTRACT

A valve control for a fluid system is provided. The valve control includes a body, a handle, a flange, a mounting bracket, and a sensor. The body is configured to be releasably connected to a port. The handle is swiveably mounted to the body. The flange is releasably connected to the body. The mounting bracket is releasably connected to the flange. The sensor is offset from the handle and adjustably connected to the mounting bracket such that the handle is configured to be bidirectionally operable.

### TECHNICAL FIELD

The present disclosure relates to a valve control, and more particularly to a valve control for a fluid system.

### BACKGROUND

Conventional valve regulators provided in fluid systems regulate a flow of fluid into or out of the fluid system. These valve regulators may include a valve and a handle. The valve may be capable of angular rotation on rotation of the associated handle. Further, the valve regulators may include sensor systems to sense an angular position of the valve. Typically, these sensor systems are mounted in congested spaces and configurations on or within a body of the valve regulator. Therefore, the positioning of the sensor systems on the valve regulators may interfere with the operation of one or more of the valve, handle, or an operator's hand. Alternatively, the positioning of the sensor systems may restrict an angular movement of the valve or handle.

### SUMMARY

In one aspect, the present disclosure provides a valve control for a fluid system. The valve control includes a body, a handle, a flange, a mounting bracket, and a sensor. The body is configured to be releasably connected to a port. The handle is swiveably mounted to the body. The flange is releasably connected to the body. The mounting bracket is releasably connected to the flange. The sensor is offset from the handle and adjustably connected to the mounting bracket such that the handle is configured to be bidirectionally operable.

In another aspect, the present disclosure provides a fluid system including a tank, and a valve control. The tank is configured to hold fluid. The valve control is operatively connected to the tank. The valve control includes the body, the handle, the flange, the mounting bracket, and the sensor. The body is releasably connected to the port of the tank. The handle is swiveably mounted to the body. The flange is releasably connected to the body. The mounting bracket is releasably connected to the flange. The sensor is offset from the handle and adjustably connected to the mounting bracket such that the handle is configured to be bidirectionally operable.

Other features and aspects of this disclosure will be apparent from the following description and the accompanying drawings.

### BRIEF DESCRIPTION OF THE DRAWINGS

FIG. 1 is an orthogonal view of a fluid system in accordance with an embodiment of the present disclosure;

FIG. 2 is a perspective view of a valve control of the fluid system;

FIG. 3 is a side view of the valve control; and

FIG. 4 shows a side view along section R-R of the fluid system of FIG. 1.

### DETAILED DESCRIPTION

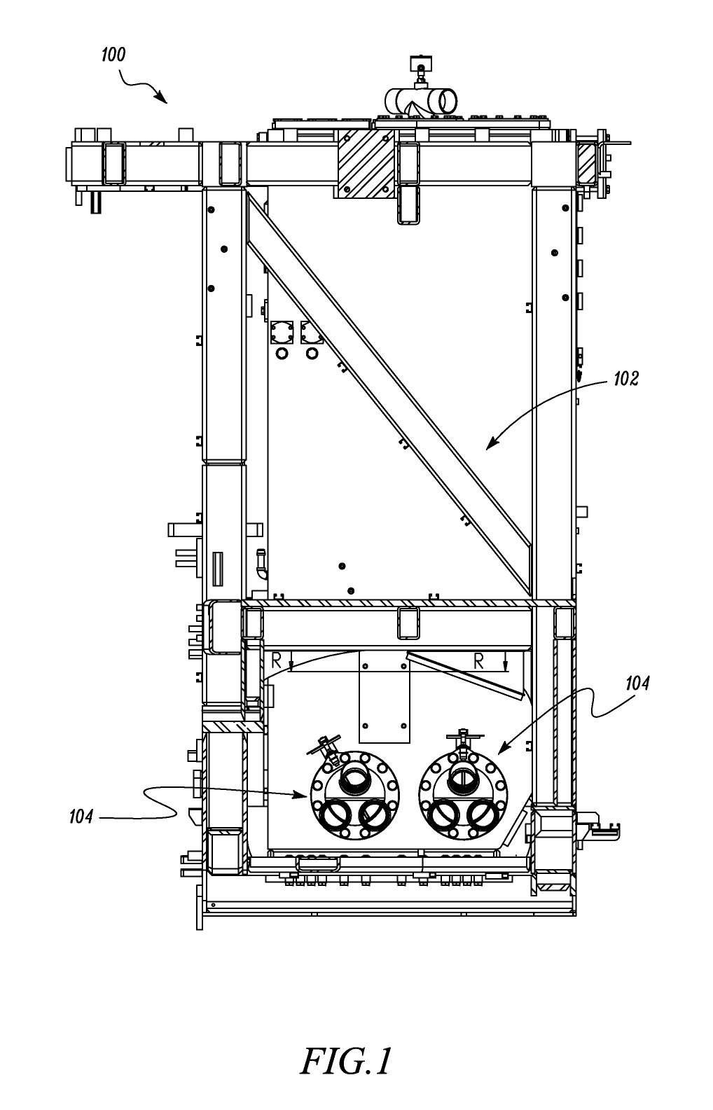

The present disclosure relates to a valve control 104 for a fluid system 100. FIG. 1 illustrates a fluid system 100 100 in accordance with an embodiment of the present disclosure. As shown in FIG. 1, the fluid system 100 may embody a hydraulic system including a tank 102, and a valve control 104. The tank 102 may be configured to hold fluid, for example, a liquid or gas. In other embodiments, the fluid system 100 may embody a pneumatic system. The fluid system 100 disclosed herein, may be used in various applications in mining and construction industry.

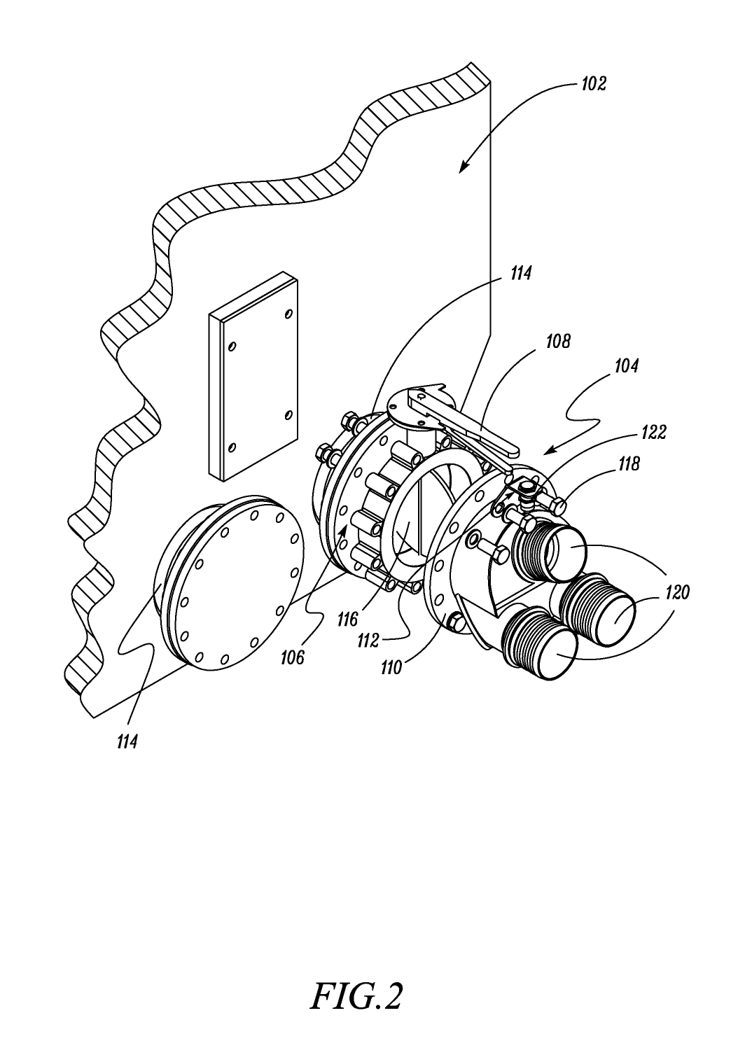

FIG. 2 shows a break away perspective view of the fluid system 100 of FIG. 1. The valve control 104 is operatively connected to the tank 102. The valve control 104 includes a body 106, a handle 108, a flange 110, and a mounting bracket 112. The body 106 is releasably connected to a port 114 of the tank 102. The handle 108 is swiveably mounted to the body 106. In one embodiment, the handle 108 is made of metal, for example, steel. In an embodiment as shown in FIG. 2, the fluid system 100 may further include a butterfly valve 116 disposed within the body 106 and operatively connected to the handle 108. Although it is disclosed herein that the fluid system 100 may include a butterfly valve 116, a person having ordinary skill in the art may acknowledge that the butterfly valve 116 disclosed herein is only exemplary in nature and does not limit the scope of this disclosure. Hence, in other embodiments, any type of valve commonly known in the art such as a ball valve may be used in lieu of the butterfly valve 116.

As shown in FIG. 2, the flange 110 is releasably connected to the body 106. In an embodiment as shown in FIG. 2, the flange 110 is releasably connected to the body 106 by bolts 118. Further, in an embodiment, the flange 110 may include one or more secondary ports 120 configured to be connected to one or more pumps (not shown). In this embodiment, the pumps may pressurize the fluid coming from the tank 102 and deliver the pressurized fluid to actuate auxiliary systems (not shown) such as shovel arms on earth moving machines (not shown).

The mounting bracket 112 is releasably connected to the flange 110. In an embodiment, the mounting bracket 112 is releasably connected to the flange 110 by bolts 118. Although it is disclosed in the preceding embodiment that the releasable connection between the mounting bracket 112 and the flange 110 is accomplished by bolts 118, a person having ordinary skill in the art will acknowledge that the releasable connection can be accomplished by other methods commonly known in the art.

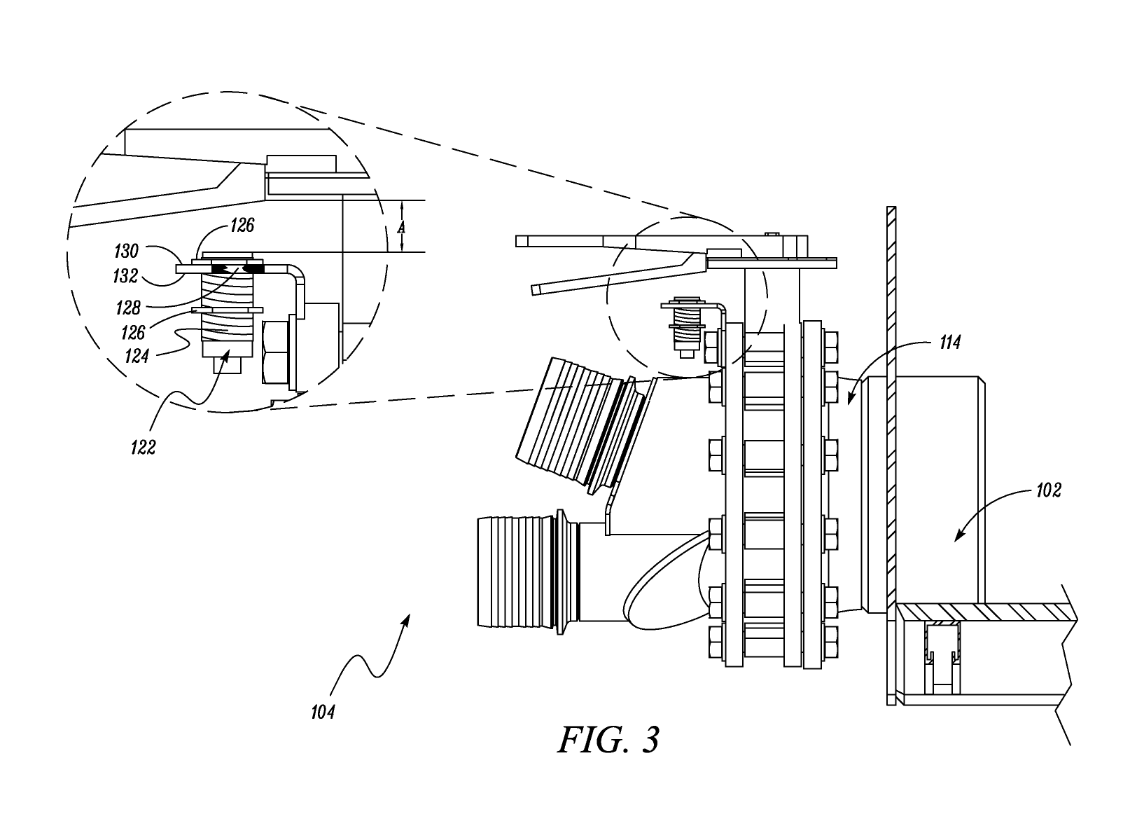

As shown in FIG. 2, the valve control 104 includes a sensor 122 adjustably connected to the mounting bracket 112. In an embodiment as shown in FIGS. 2-3, the mounting bracket 112 is L-shaped. In other embodiments the mounting bracket 112 may be Z-shaped, or U-shaped. Although in the preceding embodiments, it is disclosed that the mounting bracket 112 is L-shaped, Z-shaped, or U-shaped, a person of ordinary skill in the art will acknowledge that the shape of the mounting bracket 112 disclosed herein is exemplary in nature and does not limit the scope of this disclosure.

As can be seen from FIG. 3, the sensor 122 is offset from the handle 108 such that the handle 108 is configured to be bidirectionally operable. Therefore, an offset distance A indicative of the offset is present between the handle 108 and the sensor 122. In an embodiment as shown in FIG. 3, the sensor 122 includes a threaded body 124 supported at a predetermined position on the mounting bracket 112 by at least a pair of nuts 126. The threaded body 124 may be inserted into an opening 128 on the mounting bracket 112. The threaded body 124 of the sensor 122 may be locked in position by fastening the pair of nuts 126, onto the threaded body 124, at each side 130, 132 of the mounting bracket 112.

Typically, different types of sensors 122 may need different offset distance As to work with associated objects and sense one or more parameters. In one embodiment, the sensor 122, disclosed herein, is an induction sensor. The induction sensor is a type of electronic proximity sensor, which detects metallic objects without touching them. In one embodiment, the metallic object disclosed herein may refer to the metallic handle 108 whose position may be detected by the induction sensor. Further, the sensor 122 may be configured to generate a signal based on the position of the handle 108. In an embodiment wherein the butterfly valve 116 is associated with the handle 108, the signal generated by the sensor 122 may be one of an ON signal and an OFF signal indicative of the butterfly valve 116 being in an open position and closed position respectively.

In an embodiment, the offset distance A is in the range of 1 millimetre to 100 millimetres. In another embodiment, the offset distance A is less than or equal to 22 millimetres. As evident from FIGS. 2-3, the sensor 122 may be positioned at the predetermined offset distance A by inserting the threaded body 124 of the sensor 122 into the opening 128 of the mounting bracket 112 and locking the threaded body 124 at a certain position by the pair of nuts 126 on either side 130, 132 of the mounting bracket 112. Although it is disclosed in preceding embodiments that the sensor 122 is an induction sensor, and that the offset distance A may range from 1 to 100 millimetres, a person having ordinary skill in the art will appreciate that any type of sensor 122 commonly known in the art may be employed to detect the position of the handle 108 from an offset distance A ranging from a few millimetres to a few metres.

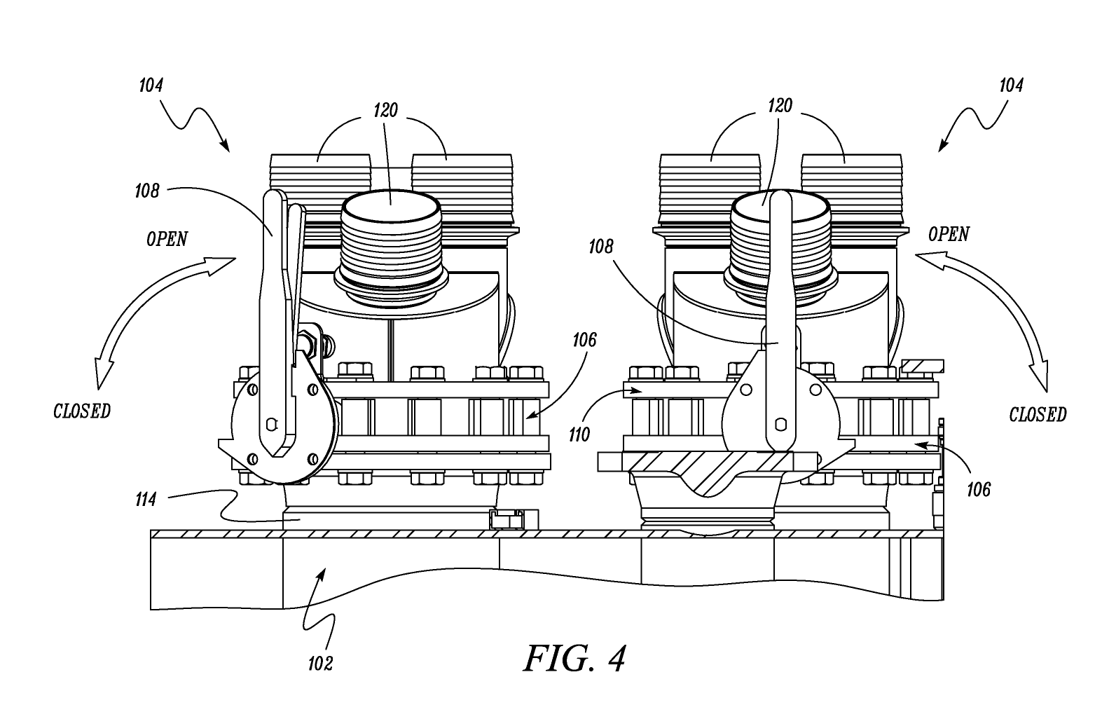

FIG. 4 illustrates the bidirectionally operable handle 108 associated with the body 106 while the sensor 122 may detect a position of the handle 108. The sensor 122 may further generate a signal based on the position of the handle 108. Further, as shown in FIG. 4, this generated signal may be an ON signal or an OFF signal indicative of the butterfly valve 116 being in an open position and closed position respectively. Although it is disclosed herein in specific embodiments that the generated signal may be an ON or OFF signal corresponding to the open or closed state of the butterfly valve 116, a person having ordinary skill in the art will acknowledge that there may be intermediate positions between the fully open and fully closed position of the butterfly valve 116 for which the sensor 122 may be additionally configured to sense the position of the handle 108 and generate a signal accordingly. Therefore, the ON and OFF signal corresponding to the open and closed position of the butterfly valve 116 disclosed herein is only exemplary in nature and does not limit the scope of this disclosure.

### INDUSTRIAL APPLICABILITY

The disclosed valve control 104 may find potential application in any fluid system 100 where it is desirable to control discharge from a tank 102 to a pump. The disclosed valve control 104 finds particular applicability as an outlet check valve in hydraulic tanks 102, especially in mining and construction machinery. One skilled in the art will acknowledge, however, that the disclosed valve control 104 may be associated with other fluid systems 100. It is further contemplated that the disclosed valve control 104 may be used to control inflow of fluid into various fluid systems 100.

Further, as shown in FIGS. 2-3 and evident from FIG. 4, the position of the sensor 122 with respect to the handle 108 enables an operator to turn the handle 108 bidirectionally. The offset distance A between the handle 108 and the sensor 122 may be sufficient enough for an operator's hand to grip and rotate the handle 108 without interference with the sensor 122 or the operation of the sensor 122. Although it may not be readily obvious to one skilled in the art, the bidirectionally rotatable feature of the handle 108 allows installation of the control valve in congested spaces normally present in complex fluid systems 100 of large construction and mining machinery. Furthermore, in an embodiment, the bidirectionally rotatable feature disclosed herein, may impart an ON-OFF-ON or an OFF-ON-OFF three way position to the butterfly valve 116 by the associated handle 108. Therefore, the handle 108 may be rotated by a left handed or a right handed operator easily and conveniently thus making the valve control 104 user friendly.

Referring to FIG. 4, the handle 108 may be operated manually to regulate a fluid flow from the tank 102 to the pump. A person having ordinary skill in the art will acknowledge that in a case when the pump is a hydraulic pump configured to be operated manually; there is a possibility that the operator may forget to keep the butterfly valve 116 in an open position prior to switching on the hydraulic pump. In such a condition, the pump may suck in air or operate in the absence of liquid thereby leading to a possible damage of several components within the pump. Further, this damage may occur without the knowledge of the operator.

The valve control 104 of the present disclosure includes the sensor 122 configured to generate a signal based on the position of handle 108 or conversely, the position of the associated butterfly valve 116. This signal may be conveyed via an electrical connector, such as a cable, to a display device, wherein an indictor light or beacon is provided. This indicator light or beacon may flash and indicate to the operator that the handle 108 or the associated butterfly valve 116 is in a closed position while the pump is in operation. Although it is disclosed herein, that an indication light or beacon is used to indicate and assist the operator in taking appropriate actions, a person having ordinary skill in the art will acknowledge that other alerting systems commonly known in the art, such as alarms, may be used.

One having ordinary skill in the art will acknowledge that hydraulic pumps may get damaged when operating in the absence of a liquid or upon entry of air. Therefore, use of the valve control 104, disclosed herein, in conjunction with such hydraulic pumps of a fluid system 100 may offset repair/replacement costs associated with damage and subsequent failure of the pump.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

We claim:

1. A valve control for a fluid system, the valve control comprising:
a body configured to be releasably connected to a port;
a handle swiveably mounted to the body;
a flange releasably connected to the body;
a mounting bracket releasably connected to the flange; and
a sensor offset from the handle and adjustably connected to the mounting bracket such that the handle is configured to be bidirectionally operable.

2. The valve control of claim 1, wherein the mounting bracket is one of L-shaped, Z-shaped, and U-shaped.

3. The valve control of claim 1, wherein the mounting bracket is releasably connected to the flange by bolts.

4. The valve control of claim 1, wherein the sensor includes a threaded body supported at a predetermined position on the mounting bracket by at least a pair of nuts.

5. The valve control of claim 1, wherein the offset distance is in the range of 1 millimetre to 100 millimetres.

6. The valve control of claim 1, wherein the sensor is an induction sensor.

7. The valve control of claim 1 further comprising a butterfly valve disposed within the body and operatively connected to the handle.

8. The valve control of claim 7, wherein the sensor is configured to detect and generate a signal based on the position of the handle.

9. The valve control of claim 8, wherein the signal is one of an ON signal and an OFF signal indicative of the butterfly valve being in an open position and closed position respectively.

10. The valve control of claim 1, wherein the flange includes one or more secondary ports configured to be connected to one or more pumps.

11. A fluid system comprising:
a tank configured to hold fluid; and
a valve control operatively connected to the tank, the valve control including:
a body releasably connected to a port of the tank;
a handle swiveably mounted to the body;
a flange releasably connected to the body;
a mounting bracket releasably connected to the flange; and
a sensor offset from the handle and adjustably connected to the mounting bracket such that the handle is configured to be bidirectionally operable.

12. The fluid system of claim 11, wherein the mounting bracket is one of L-shaped, Z-shaped, and U-shaped.

13. The fluid system of claim 11, wherein the mounting bracket is releasably connected to the flange by bolts.

14. The fluid system of claim 11, wherein the sensor includes a threaded body supported at a predetermined position on the mounting bracket by at least a pair of nuts.

15. The fluid system of claim 11, wherein the offset distance is in the range of 1 millimetre to 100 millimetres.

16. The fluid system of claim 1, wherein the sensor is an induction sensor.

17. The fluid system of claim 11 further comprising a butterfly valve disposed within the body and operatively connected to the handle.

18. The fluid system of claim 17, wherein the sensor is configured to detect and generate a signal based on the position of the handle.

19. The fluid system of claim 18, wherein the signal is one of an ON signal and an OFF signal indicative of the butterfly valve being in an open position and closed position respectively.

20. The fluid system of claim 11, wherein the flange includes one or more secondary ports configured to be connected to one or more pumps.
